(19) United States
(12) Patent Application Publication
(10) Pub. No.: US 2019/0353825 A1
(43) Pub. Date: Nov. 21, 2019

(54) PROJECTION-BASED EMBEDDED DISCRETE FRACTURE MODEL (PEDFM)

(71) Applicant: Khalifa University of Science and Technology, Abu Dhabi (AE)

(72) Inventors: Matei TENE, Delft (NL); Hadi HAJIBEYGI, Delft (NL); Mohammed AL KOBAISI, Abu Dhabi (AE)

(21) Appl. No.: 16/413,151

(22) Filed: May 15, 2019

Related U.S. Application Data
(60) Provisional application No. 62/671,588, filed on May 15, 2018.

(51) Int. Cl. G01V 99/00; G06F 17/50

(52) U.S. Cl. CPC G01V 99/005; G06F 2217/16; G06F 17/5018

(57) ABSTRACT

A projection-based embedded discrete fracture model (pEDFM) method for simulation of flow through subsurface formations. The pEDFM includes independently defining one or more fracture and a matrix grids, identifying cross-media communication points, and adjusting one or more matrix-matrix and a fracture-matrix transmissibilities in a vicinity of a fracture network. The pEDFM allows for accurately modeling the effect of fractures with general conductivity contrasts relative to the matrix, including impermeable flow barriers. This may be achieved by automatically adjusting the matrix transmissibility field, in accordance to the conductivity of neighboring fracture networks, alongside the introduction of additional matrix-fracture connections.

### CROSS REFERENCE TO RELATED APPLICATIONS

The present disclosure claims the benefit of U.S. Provisional Patent Application Ser. No. 62/671,588 filed May 15, 2018, which is fully incorporated herein by reference.

### FIELD

The present disclosure is directed to an embedded discrete fracture model.

### BACKGROUND

Accurate and efficient simulation of flow through subsurface formations is useful for effective engineering operations (including production, storage optimization and safety assessments). Alongside their intrinsic heterogeneous properties, target geological formations often contain relatively complex networks of naturally-formed or artificially-induced fractures, with a relatively wide range of fluid conductivity properties. Given their relatively significant impact on flow patterns, accurate representation of these lower-dimensional structural features is paramount for the quality of the simulation results (Berkowitz, B., 2002. Characterizing flow and transport in fractured geological media: a review. Adv. Water Res. 25 (8-12), 861-884, which is fully incorporated herein by reference). Discrete Fracture Models (DFM) may reduce the dimensionality of the problem by constraining the fractures, as well as any inhibiting flow barriers, to lie at the interfaces between matrix rock cells (Ahmed, R., Edwards, M. G., Lamine, S., Huisman, B. A., Pal, M., 2015. Three-dimensional control-volume distributed multi-point flux approximation coupled with a lower-dimensional surface fracture model. J. Comput. Phys. 303, 470-497; Karimi-Fard, M., Durlofsky, L. J., Aziz, K., 2004. An efficient discrete fracture model applicable for general purpose reservoir simulators. SPE J. 9 (2), 227-236; and Reichenberger, V., Jakobs, H., Bastian, P., Helmig, R., 2006. A mixed-dimensional finite volume method for two-phase flow in fractured porous media. Adv. Water Resource 29 (7), 1020-1036, all of which are fully incorporated herein by reference). Then, local grid refinements may be applied, where a relatively higher level of detail is necessary, leading to a discrete representation of the flow equations on, sometimes complex, unstructured grids (Karimi-Fard, M., Durlofsky, L. J., 2016. A general gridding, discretization, and coarsening methodology for modeling flow in porous formations with discrete geo-logical features. Adv Water Resource. 96 (6), 354-372; Matthai, S. K., Mezentsev, A. A., Belayneh, M., 2007. Finite element node-centered finite-volume two-phase-flow experiments with fractured rock represented by unstructured hybrid-element meshes. SPE Reservoir Eval. Eng. 10, 740-756; Sahimi, M., Darvishi, R., Haghighi, M., Rasaei, M. R., 2010. Upscaled unstructured computational grids for efficient simulation of flow in fractured porous media. Transp. Porous Media 83 (1), 195-218; Schwenck, N., Flemisch, B., Helmig, R., Wohlmuth, B., 2015. Dimensionally reduced flow models in fractured porous media: crossings and boundaries. Comput. Geosci. 19 (1), 1219-1230; and Tatomir, A., Szymkiewicz, A., Class, H., Helmig, R., 2011. Modeling two phase flow in large scale fractured porous media with an extended multiple interacting continua method. Comput. Model. Eng. Sci. 77 (2), 81, all of which are fully incorporated herein by reference). Although the DFM approach has been extended to include complex fluids and rock physics—e.g. compositional displacements (Moortgat, J., Amooie, M., Soltanian, M., 2016. Implicit finite volume and discontinuous galerkin methods for multicomponent flow in unstructured 3d fractured porous media. Adv. Water Resour. 96, 389-404; Moortgat, J., Firoozabadi, A., 2013. Three-phase compositional modeling with capillarity in heterogeneous and fractured media. SPE J. 18, 1150-1168; and Firoozabadi, 2013, all of which are fully incorporated herein by reference) and geomechanical effects (Garipov, T. T., Karimi-Fard, M., Tchelepi, H. A., 2016. Discrete fracture model for coupled flow and geomechanics. Comput. Geosci. 20 (1), 149-160, all of which are fully incorporated herein by reference)—its reliance on relatively complex computational grids may raise challenges in real-field applications. This has led to the emergence of models which make use of non-conforming grids with respect to fracture-matrix connections, such as Extended Finite Element Methods (XFEM, see Flemisch, B., Fumagalli, A., Scotti, A., 2016. A review of the XFEM-based approximation of flow in fractured porous media. In: Advances in Discretization Methods. Springer, pp. 47-76, which is fully incorporated herein by reference) and Embedded Discrete Fracture Models (EDFM, introduced in Lee, S. H., Jensen, C. L., Lough, M. F., 2000. Efficient finite-difference model for flow in a reservoir with multiple length-scale fractures. SPE J. 3,268-275 and Li, L., Lee, S. H., 2008. Efficient field-scale simulation of black oil in naturally fractured reservoir through discrete fracture networks and homogenized media. SPE Reservoir Eval. Eng. 11,750-758, both of which are fully incorporated herein by reference). The latter are appealing due to their ability to deliver mass-conservative flux fields. To this end, the lower-dimensional structural features with relatively small lengths (i.e. fully contained in a single fine-scale matrix cell) are first homogenized, by altering the effective permeability of their support rock (Pluimers, 2015). Then, the remaining fracture networks are discretized on separate numerical grids, defined independently from that of the matrix (Deb, R., Jenny, P., 2016. Numerical modeling of flow-mechanics coupling in a fractured reservoir with porous matrix. Proc. 41st Workshop Geotherm. Reservoir Eng., Stanford, Calif., February 22-24, S GP-TR-209.1-9 and Karvounis, D., Jenny, P., 2016. Adaptive hierarchical fracture model for enhanced geothermal systems. Multiscale Model. Simul. 14 (1), 207-231, both of which are fully incorporated herein by reference). A comprehensive comparison between DFM and EDFM, along with other fracture models, is performed by (Flemisch, B., Berre, I., Boon, W., Fumagalli, A., Schwenck, N., Scotti, A., Stefansson, I., Tatomir, A., 2017. Benchmarks for single-phase flow in fractured porous media. ArXiv:1701.01496, which is fully incorporated herein by reference). The EDFM has been applied to reservoirs containing relatively highly-conductive fractures with relatively complex geometrical configurations, while considering compositional fluid physics (Moinfar, A., Varavei, A., Sepehrnoori, K., Johns, R. T., 2014. Development of an efficient embedded discrete fracture model for 3d compositional reservoir simulation in fractured reservoirs. SPE J. 19, 289-303, which is fully incorporated herein by reference) and plastic and elastic deformation (Norbeck, J. H., McClure, M. W., Lo, J. W., Horne, R. N., 2016. An embedded fracture modeling framework for simulation of hydraulic fracturing and shear stimulation. Comput. Geosci. 20 (1), 1-18, which is fully incorporated herein by reference). It has been used as an upscaling technique (Fumagalli, A., Pasquale, L., Zonca, S., Micheletti, S., 2016. An upscaling procedure for fractured reservoirs with embedded grids. Water Resour. Res. 52 (8), 6506-6525 and Fumagalli, A., Zonca, S., Formaggia, L., 2017. Advances in computation of local problems for a flow-based upscaling in fractured reservoirs. Math. Comput. Simul. 137, 299-324, both of which are fully incorporated herein by reference) and has been paired with multiscale methods for efficient flow simulation (Hajibeygi, H., Karvounis, D., Jenny, P., 2011. A hierarchical fracture model for the iterative multiscale finite volume method. J. Comput. Phys. 230, 8729-8743; Shah, S., Moyner, O., Tene, M., Lie, K.-A., Hajibeygi, H., 2016. The multiscale restriction smoothed basis method for fractured porous media (F-MsRSB). J. Comput. Phys. 318, 36-57; Tene, M., Al Kobaisi, M., Hajibeygi, H., 2016. Multiscale projection-based Embedded Discrete Fracture Modeling approach (F-AMS-pEDFM). In: ECMOR XV-15th European Conference on the Mathematics of Oil Recovery; and Tene, M., Al Kobaisi, M. S., Hajibeygi, H., 2016. Algebraic multiscale method for flow in heterogeneous porous media with embedded discrete fractures (F-AMS). J. Comput. Phys. 321, 819-845, all of which are fully incorporated herein by reference). However, the experiments presented below show that, in its current formulation, the model is not suitable in cases when the fracture permeability lies below that of the matrix. In addition, even when fractures coincide with the interfaces of matrix cells, the existing EDFM formulation still allows for independent flow leakage (i.e. disregarding the properties of the fracture placed between neighboring matrix cells).

Accordingly, room for improvement remains to resolve these limitations.

### BRIEF DESCRIPTION OF THE DRAWINGS

The above-mentioned and other features of this disclosure and the manner of attaining them will become more apparent with reference to the following description of embodiments herein taking in conjunction with the accompanying drawings, wherein:

FIG. 1A illustrates an embodiment of the matrix domain. In pEDFM, independent grids are defined separately for the matrix and fracture domains.

FIG. 1B illustrates an embodiment of the fractured domain. In pEDFM, independent grids are defined separately for the matrix and fracture domains.

FIG. 2 illustrates an embodiment of pEDFM on a 2D structured grid. The matrix cells highlighted in yellow are connected directly to the fracture, as defined in the classic EDFM. The cells highlighted in orange take part in the additional non-neighboring connections between fracture and matrix grid cells, as required by pEDFM.

FIG. 3A illustrates log₁₀(k) on the 1001×1001 fully resolved grid.

FIG. 3B illustrates log₁₀(k) on the 11×11 pEDFM grid.

FIG. 3C illustrates fully-resolved pressure solutions in a homogeneous reservoir containing a “+”-shaped highly-conductive fracture network (top).

FIG. 3D illustrates EDFM pressure solutions in a homogeneous reservoir containing a “+”-shaped highly-conductive fracture network (top).

FIG. 3E illustrates pEDFM pressure solutions in a homogeneous reservoir containing a “+”-shaped highly-conductive fracture network (top).

FIG. 4A illustrates log₁₀(k) on the 1001×1001 fully resolved grid.

FIG. 4B illustrates log₁₀(k) on the 11×11 pEDFM grid.

FIG. 4C illustrates fully-resolved pressure solutions in a homogeneous reservoir containing a “+”-shaped highly-conductive fracture network (top).

FIG. 4D illustrates EDFM pressure solutions in a homogeneous reservoir containing a “+”-shaped highly-conductive fracture network (top).

FIG. 4E illustrates pEDFM pressure solutions in a homogeneous reservoir containing a “+”-shaped highly-conductive fracture network (top).

FIG. 5A illustrates the horizontal fracture of the “+”-shaped network successively moved from the top to the bottom of a 2-grid cell window (the top being at the left of the figure and the bottom at the right of the figure) while monitoring the pressure mismatch towards the corresponding fully resolved simulation (see FIG. 5B) to determine the sensitivity of pEDFM to the position of highly conductive fractures, embedded within the matrix grid cells.

FIG. 5B illustrates the pressure mismatch towards the corresponding fully resolved simulation.

FIG. 6A illustrates the sensitivity of the pEDFM to the position of nearly impermeable fracture, embedded within the matrix grid cells. The vertical fracture of the “+”-shaped network is successively moved from left to right over a 2-grid cell window (top), while monitoring the pressure mismatch towards the corresponding fully resolved simulation of FIG. 6B.

FIG. 6B illustrates the pressure mismatch towards the corresponding fully resolved simulation.

FIG. 7A illustrates an embodiment of a pressure error map when Nx=Ny=3⁶ (or h=0.0015) illustrating grid resolution sensitivity of pEDFM with high conductive fractures.

FIG. 7B illustrates an embodiment of a pressure error map when Nx=Ny=3⁶ (or h=0.0015) illustrating grid resolution sensitivity of EDFM with high conductive fractures.

FIG. 7C illustrates an embodiment of a pressure error map when Nx=Ny=3⁶ (or h=0.0015) illustrating grid resolution sensitivity of DFM with high conductive fractures.

FIG. 7D illustrates grid resolution sensitivity of pEDFM, EDFM, DFM.

FIG. 8A illustrates an embodiment of a pressure error map when Nx=Ny=3⁶ (or h=0.0015) illustrating grid resolution sensitivity of pEDFM with nearly impermeable fractures.

FIG. 8B illustrates an embodiment of a pressure error map when Nx=Ny=3⁶ (or h=0.0015) illustrating grid resolution sensitivity of EDFM with nearly impermeable fractures.

FIG. 8C illustrates an embodiment of a pressure error map when Nx=Ny=3⁶ (or h=0.0015) illustrating grid resolution sensitivity of DFM with nearly impermeable fractures.

FIG. 8D illustrates grid resolution sensitivity of pEDFM, EDFM, DFM.

FIG. 9A illustrates an embodiment of a pressure error map when k^{f}=10⁻⁵, illustrating the sensitivity of pEDFM to the fracture-matrix conductivity contrast on the “+”-shaped fracture network case with a grid resolution of 3⁵×3⁵.

FIG. 9B illustrates an embodiment of a pressure error map when k^{f}=1, illustrating the sensitivity of pEDFM to the fracture-matrix conductivity contrast on the “+”-shaped fracture network case with a grid resolution of 3⁵×3⁵.

FIG. 9C illustrates an embodiment of a pressure error map when k^{f}=10⁵, illustrating the sensitivity of pEDFM to the fracture-matrix conductivity contrast on the “+”-shaped fracture network case with a grid resolution of 3⁵×3⁵.

FIG. 9D illustrates the sensitivity of pEDFM to the fracture-matrix conductivity contrast on the “+”-shaped fracture network case with a grid resolution of 3⁵×3⁵.

FIG. 10A illustrates a fracture permeability at log₁₀(k) on a 2D test case with homogenous matrix conductivity under incompressible 2-phase flow conditions.

FIG. 10B illustrates a pressure field on a 2D test case with homogenous matrix conductivity under incompressible 2-phase flow conditions.

FIG. 10C illustrates a time-lapse saturation result at 0.1 PVI on a 2D test case with homogenous matrix conductivity under incompressible 2-phase flow conditions.

FIG. 10D illustrates a time-lapse saturation result at 0.2 PVI on a 2D test case with homogenous matrix conductivity under incompressible 2-phase flow conditions.

FIG. 10E illustrates a time-lapse saturation result at 0.3 PVI on a 2D test case with homogenous matrix conductivity under incompressible 2-phase flow conditions.

FIG. 10F illustrates a time-lapse saturation result at 0.4 PVI on a 2D test case with homogenous matrix conductivity under incompressible 2-phase flow conditions.

FIG. 10G illustrates a time-lapse saturation result at 0.5 PVI on a 2D test case with homogenous matrix conductivity under incompressible 2-phase flow conditions.

FIG. 11A illustrates a heterogenous matrix and fracture permeability map at log¹⁰(k^{m}) on a 2D densely fractured test case, under incompressible 2-phase flow conditions.

FIG. 11B illustrates a heterogenous matrix and fracture permeability map at log¹⁰(k^{f}) on a 2D densely fractured test case, under incompressible 2-phase flow conditions.

FIG. 11C illustrates a pressure map for EDFM on a 2D densely fractured test case, under incompressible 2-phase flow conditions.

FIG. 11D illustrates a time-lapse saturation for EDFM at 0.1 PVI on a 2D densely fractured test case, under incompressible 2-phase flow conditions.

FIG. 11E illustrates a time-lapse saturation for EDFM at 0.3 PVI on a 2D densely fractured test case, under incompressible 2-phase flow conditions.

FIG. 11F illustrates a time-lapse saturation for EDFM at 0.5 PVI on a 2D densely fractured test case, under incompressible 2-phase flow conditions.

FIG. 11G illustrates a pressure map for pEDFM on a 2D densely fractured test case, under incompressible 2-phase flow conditions.

FIG. 11H illustrates a time-lapse saturation for pEDFM at 0.1 PVI on a 2D densely fractured test case, under incompressible 2-phase flow conditions.

FIG. 11I illustrates a time-lapse saturation for pEDFM at 0.3 PVI on a 2D densely fractured test case, under incompressible 2-phase flow conditions.

FIG. 11J illustrates a time-lapse saturation for pEDFM at 0.5 PVI on a 2D densely fractured test case, under incompressible 2-phase flow conditions.

FIG. 12A illustrates a 3D domain containing a first layer of fractures at log₁₀(k^{f}).

FIG. 12B illustrates a 3D domain containing a second layer of fractures at log₁₀(k^{f}).

FIG. 12C illustrates a 3D domain containing a third layer of fractures at log₁₀(k^{f}).

FIG. 13 illustrates a fracture-containing unstructured grid constructed by DFM for the 3D test case.

FIG. 14A illustrates pressures obtained using DFM for a 3D incompressible single-phase test case with 3 layers of heterogenous fractures (same scale as FIG. 14B).

FIG. 14B illustrates pressures obtained using pEDFM for a 3D incompressible single-phase test case with 3 layers of heterogenous fractures.

FIG. 15A illustrates an analytical calculation of the average distance between a fracture and a matrix cell on 2D structure grids. Triangles 3 and 4 overlap with triangles 1 or 2.

FIG. 15B illustrates an analytical calculation of the average distance between a fracture and a matrix cell on 2D structure grids. Triangles 3 and 4 overlap with triangles 1 or 2.

FIG. 15C illustrates an analytical calculation of the average distance between a fracture and a matrix cell on 2D structure grids. When the fracture coincides with cell diagonal, triangles 3 and 4 have zero area.

FIG. 15D illustrates an analytical calculation of the average distance between a fracture and a matrix cell on 2D structure grid when the fractures lie outside the cell.

FIG. 15E illustrates an analytical calculation of the average distance between a fracture and a matrix cell on 2D structure grid, if the fracture is aligned with one of the axes, two rectangles are formed.

### DETAILED DESCRIPTION

The present disclosure is directed to a formulation for embedded fracture approaches, namely, the projection-based embedded discrete fracture model (pEDFM). The pEDFM accommodates lower-dimensional structural features with a relatively wide range of permeability contrasts towards the matrix. This includes relatively highly conductive fractures and flow barriers with relatively small apertures, relative to the reservoir scale, which allows their representation as 2D plates. These features are referred to, simply, as fractures, regardless of their conductive properties. The devised pEDFM formulation retains the geometric flexibility of the classic EDFM procedure. More specifically, once the fracture and matrix grids are independently defined, and the cross-media communication points are identified, pEDFM adjusts the matrix-matrix and fracture-matrix transmissibilities in the vicinity of fracture networks. This provides that the conductivity of the fracture networks, which can be several orders of magnitude below or above that of the matrix, are taken into account, preferably automatically, when constructing the flow patterns. Finally, when fractures are explicitly placed at the interfaces of matrix cells, pEDFM provides, preferably automatically, identical results to DFM.

To accommodate fractures with a relatively wide range of conductivity contrasts towards the matrix, pEDFM extends the classic EDFM discretization of the governing flow equations by automatically scaling the matrix-matrix connections in the vicinity of fracture networks. At the same time, additional fracture-matrix connections are added to keep the system of equations well-posed in all, or nearly all, possible scenarios as explained further below.

The mass-conservation equations for isothermal Darcy flow in fractured media, without compositional effects, can be written as:

$${[ \frac{\partial ( {φρ}_{i} {s}_{i} )}{\partial t} - ∇ \cdot ( {ρ}_{i} {λ}_{i} \cdot ∇ p ) ]}^{m} = {Q}^{m} + {[ {ρ}_{i} q ]}^{mf} on {Ω}^{m} ⋐ {R}^{n} \qquad ( 1 )$$

for the matrix (superscript^{m}) and

$${[ \frac{\partial ( {φρ}_{i} {s}_{i} )}{\partial t} - ∇ \cdot ( {ρ}_{i} {λ}_{i} \cdot ∇ p ) ]}^{f} = {Q}^{f} + {[ {ρ}_{i} q ]}^{fm} on {Ω}^{f} ⋐ {R}^{n - 1} \qquad ( 2 )$$

for the fracture (superscript^{f}) spatial domains. Here, ϕ is the rock porosity, p the pressure, while sᵢ, λᵢ and ρᵢ are the phase saturation, mobility and density, respectively. The q^{mf} and q^{fm} stand for the cross-media connections, while Q^{m} and Q^{f} are source terms, e.g. due to perforating wells, capillary and gravity effects, in the matrix and fracture domain, respectively.

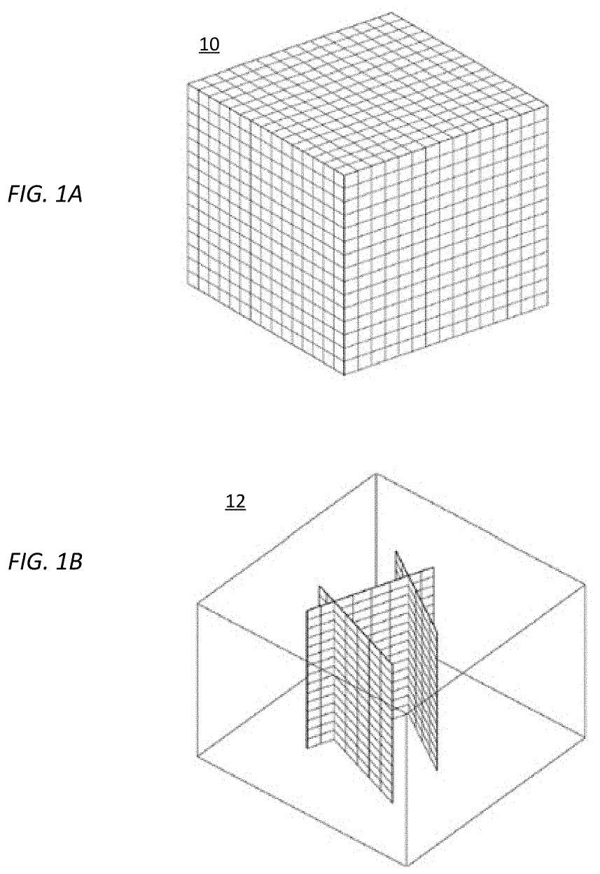

To solve the coupled system of Eqs. (1) and (2), independent grids are generated for the rock and fracture domains (See FIGS. 1A and 1B, illustrating a matrix grid 10 and fracture grid 12, respectively). This approach alleviates complexities related to grid generation, since, unlike in DFM, fractures do not need to be confined to the interfaces between matrix grid cells. The advection term from Eqs. (1) and (2) is defined for each (matrix-matrix and fracture-fracture) grid interface, following the two-point-flux approximation (TPFA) finite volume discretization of the flux Fᵢⱼ between each pair of neighboring cells i and j as:

Fᵢⱼ=Tᵢⱼ(pᵢ−pⱼ) (3)

Here,

$${T}_{ij} = \frac{{A}_{ij}}{{d}_{ij}} {\overline{λ}}_{ij}$$

is the transmissibility, Aij is the interfacial area, dij is the distance between the cell centers, λ̅ᵢⱼ is the effective fluid mobility at the interface between i and j (absolute permeabilities are harmonically averaged, fluid properties are upwinded (Chen, Z., 2007. Reservoir simulation: mathematical techniques in oil recovery. SIAM, which is fully incorporated herein by reference). The fracture-matrix coupling terms are modelled similar to Hajibeygi et al. (2011); Li and Lee (2008), i.e., for matrix cell i (with volume Vi) connected to a fracture cell f (of area Af),

$$\begin{matrix}{F}_{if} = {\int }_{{V}_{i}} {q}_{if}^{mf} dV = {T}_{if} ( {p}_{f} - {p}_{i} ) & ( 4 ) \\ and & \\ {F}_{fi} = {\int }_{{A}_{f}} {q}_{fi}^{fm} dA = {T}_{fi} ( {p}_{i} - {p}_{f} ) , & ( 5 )\end{matrix}$$

where T_{if}=CI_{if} λ_{if}=T_{fi} is the cross-media transmissibility. In addition, λ_{if} is the effective fluid mobility at the interface between matrix and fracture (just as before, absolute permeabilities are harmonically averaged, fluid properties are upwinded), while the CI_{if} is the conductivity index, defined as:

$${CI}_{if} = \frac{{S}_{if}}{{〈 d 〉}_{if}} , \qquad ( 6 )$$

where S_{if} is the surface area of the connection (further specified below) and <d>_{if} is the average distance between the points contained in the rock control volume Vᵢ and the fracture surface A_{f} (Hajibeygi et al., 2011; Li and Lee, 2008), i.e.:

$${〈 d 〉}_{if} = \frac{1}{{V}_{i}} {\int }_{{Ω}_{i}} {d}_{if} {dv}_{i} , \qquad ( 7 )$$

where d_{if} stands for the distance between finite volume dᵥᵢ and fracture plate. An example of an analytical method for its computation on 2D structured grids is described further below.

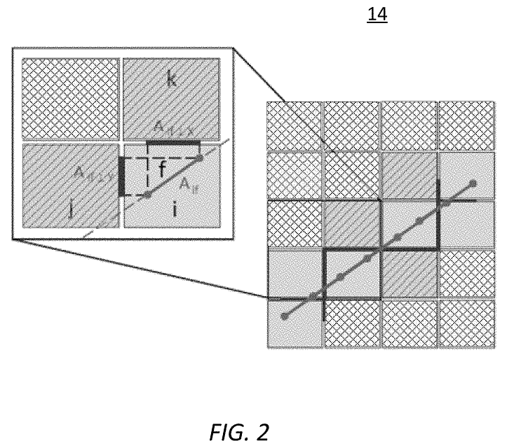

Considering now the fractured medium from FIG. 2, which is discretized on a structured grid 14. Let A_{if} be the area of intersection between fracture cell f and matrix volume i (highlighted by the unhatched area in FIG. 2). The classical EDFM formulation (Hajibeygi et al., 2011; Li and Lee, 2008) defines the transmissibility as:

$${T}_{if} = \frac{2 {A}_{if}}{{〈 d 〉}_{if}} {λ}_{if} \qquad ( 8 )$$

where, in this case, S_{if}=2 A_{if} for computing CI in Eq. (6) and kᵢₜ' is the effective cross-media mobility. The transmissibility of the matrix-matrix connections in the neighborhood of the fracture (between control volumes i and j, k, respectively) are left unmodified from their TPFA finite volumes form, i.e.:

$${T}_{ij} = \frac{{A}_{ij}}{Δ x} {λ}_{ij} {T}_{ik} = \frac{{A}_{ik}}{Δ y} {λ}_{ik} . \qquad ( 9 )$$

where Aᵢⱼ, Aᵢₖ are the areas and λᵢⱼ, λᵢₖ the effective mobilities of the corresponding matrix interfaces.

By then modifying the matrix-matrix and fracture-matrix in the vicinity of fractures, an extension to the EDFM formulation may be made. This enables the development of a general embedded discrete fracture modeling approach (pEDFM), applicable in cases with conductivity contrast between fractures and matrix. To this end, first a set of matrix-matrix interfaces is preferably selected, such that they define a continuous projection path of each fracture network on the matrix domain (highlighted by the diagonal hatching on the right side of FIG. 2). It is preferable to ensure the continuity of the paths each fracture network. Consider fracture cell f intersecting matrix volume i on an n-dimensional structured grid over a surface area, A_{if}. Let A_{if⊥xe} be its corresponding projections on the path, along each dimension, e=1, . . . , n (highlighted by the diagonal hatching on the left side of FIG. 2). Also, let iₑ be the matrix control volumes which reside on the opposite side of the interfaces affected by the fracture cell projections (highlighted by the unhatched areas in FIG. 2). Then, the following transmissibilities are preferably defined:

$${T}_{if} = \frac{{A}_{if}}{{〈 d 〉}_{if}} {λ}_{if} , {T}_{{i}_{e} f} = \frac{{A}_{if ⊥ {x}_{e}}}{{〈 d 〉}_{{i}_{e} f}} {λ}_{{i}_{e} f} and {Tii}_{e} = \frac{{A}_{{ii}_{e}} - {A}_{if ⊥ {x}_{e}}}{{Δx}_{e}} λ {ii}_{e} , \qquad ( 10 )$$

where Aᵢᵢₑ are the areas of the matrix interfaces hosting the fracture cell projections and λ_{if}, λ_{ief}, λᵢᵢₑ are effective fluid mobilities between the corresponding cells. Notice that the projected areas, A_{if⊥xe}, are eliminated from the matrix-matrix transmissibilities and, instead, make the object of stand-alone connections between the fracture and the non-neighboring (i.e. not directly intersected) matrix cells iₑ. Also, the matrix-matrix connectivity Tᵢᵢₑ will be eventually zero if the fracture elements (belonging to one or multiple fractures) cross through the entire matrix cell i. Finally, note that, for fractures that are explicitly confined to lie along the interfaces between matrix cells, the pEDFM formulation, as given in Eq. (10), naturally reduces to the DFM approach on unstructured grids, while the EDFM does not. Given the above TPFA finite-volume discretization of the advection and source terms from Eqs. (1) and (2), after applying backward Euler time integration, the coupled system is linearized with the Newton-Raphson scheme and solved iteratively.

### EXAMPLES

### Sensitivity Studies

Numerical experiments of single- and two-phase incompressible flow through two- and three-dimensional fractured media were performed to validate pEDFM, presented above, and study its sensitivity to fracture position, grid resolution and fracture-matrix conductivity contrast, respectively. The reference solution for these studies is obtained on a fully resolved grid, i.e. where the size of each cell is equal to the fracture aperture. This allows the following model error measurement:

$$\frac{{\vert \vert ϵ \vert \vert}_{1}}{{N}_{coarse}} = \frac{{\sum }_{1}^{N} \vert {p}_{fine}^{′} - {p}_{coarse} \vert}{{N}_{coarse}} \qquad ( 11 )$$

where N_{coarse} is the number of grid cells used by pEDFM and p′_{fine} is the corresponding fully-resolved pressure, interpolated to the coarse scale, if necessary. Some of the experiments were repeated for the classic EDFM, as well as unstructured DFM, for comparison purposes. For simplicity, but without loss of generality, the flow in these experiments is driven by Dirichlet boundary conditions, instead of injection and production wells, while capillary and gravity effects are neglected. Finally, the simulations were performed using the DARSim 1 inhouse simulator, using a sequentially implicit strategy for the multiphase flow cases.

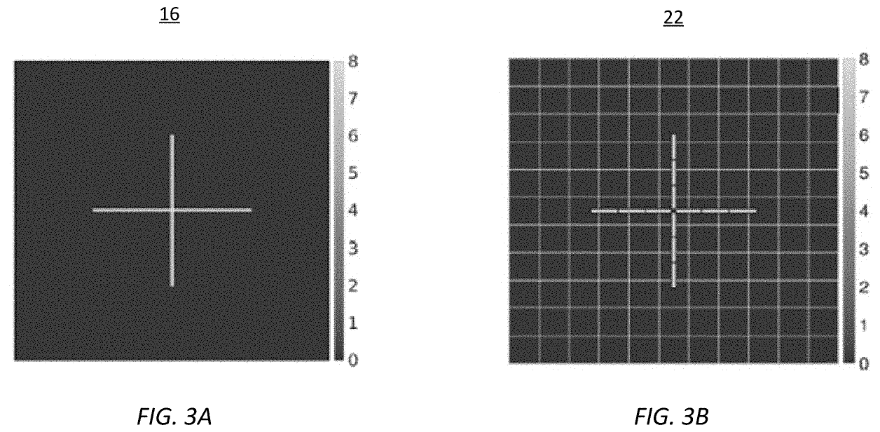

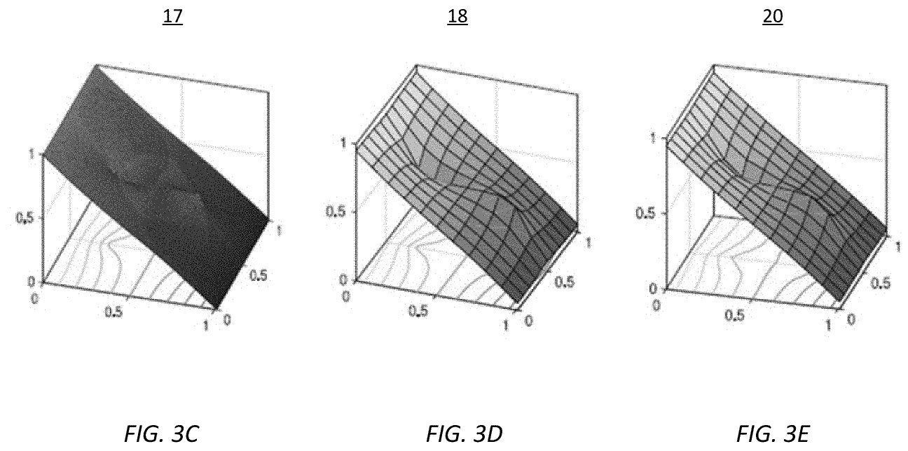

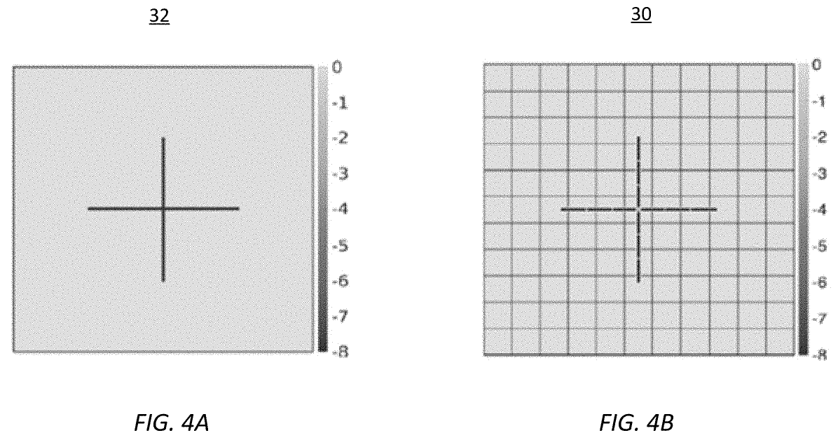

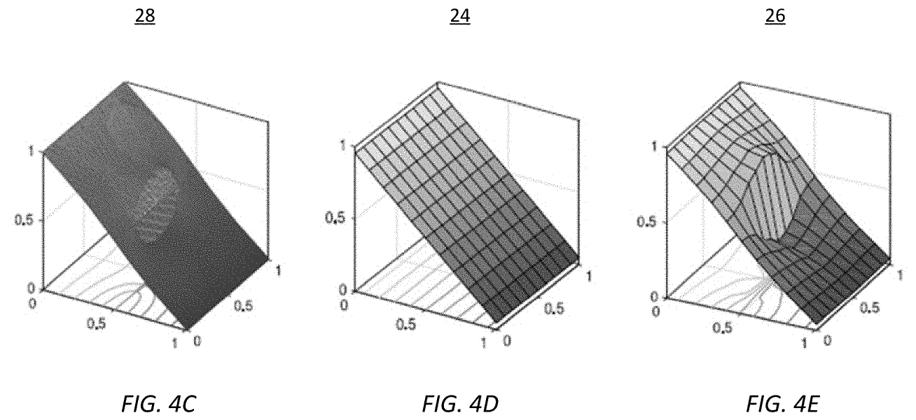

To validate pEDFM as a fine-scale model suitable to accommodate fractures with a wide range of permeabilities, a 2D homogeneous domain (k^{m}=1) is considered, having a “+”-shaped fracture network, located in the middle. To drive the incompressible single-phase flow, Dirichlet boundary conditions with non-dimensional pressure values of p=1 and p=0 are imposed on the left and right boundaries of the domain, respectively, while the top and bottom sides are subject to no-flow conditions. As shown in FIGS. 3A through 3E, the study is first conducted in a scenario where the fractures are 8 orders of magnitude more conductive than the matrix. The reference solution 17 (FIG. 3C), in this case, is computed on a 1001×1001 structured cartesian grid 16 (FIG. 3A). From FIGS. 3D through 3E, it is illustrated that both EDFM 18 and pEDFM 20, respectively, on a coarser 11×11 domain 22 (FIG. 3B), can reproduce the behavior of the flow as dictated by the highly-conductive embedded fracture network. As shown in FIGS. 4A through 4E, the same experiment was rerun for the case where the fracture permeability lies 8 orders of magnitude below that of the host matrix. The results expose the limitations of EDFM 24 (FIG. 4D), where the impermeable fractures are simply by-passed by the flow through the (unaltered) matrix, resulting in a pressure field corresponding to a reservoir with homogeneous (non-fractured) permeability. On the other hand, through its new formulation, pEDFM 26 (FIG. 4E) is able to reproduce the effect of the inhibiting flow barrier, confirming its applicability to this case. These experiments confirm that pEDFM 26 is a suitable extension of EDFM 24 to a wider range of geological scenarios, being able to reproduce the correct flow behavior 28 (FIG. 4C) in the presence of both high and low permeable fractures, embedded in the porous matrix.

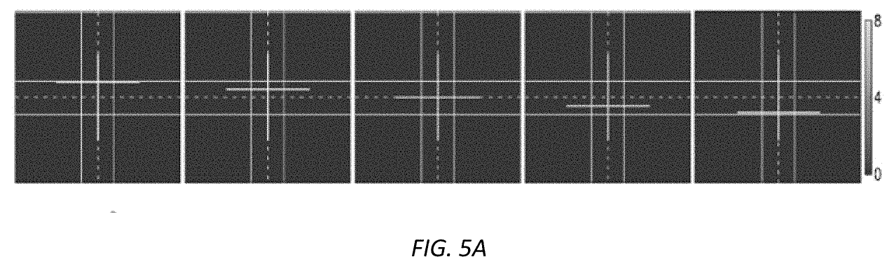

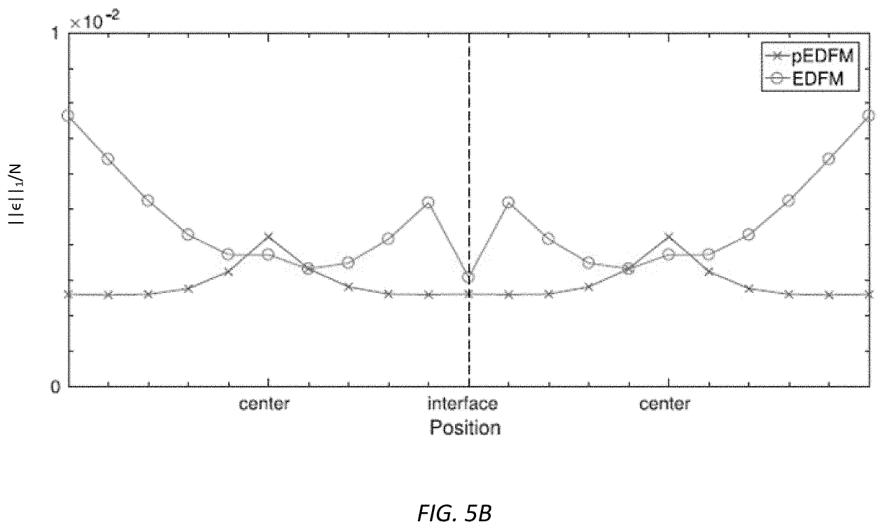

Given that pEDFM typically operates on much coarser grids 30 (FIG. 4B) than the fully resolved case 32 (FIG. 4A), it is of interest to elicit its sensitivity to the fracture position within the host grid cell. To this end, the “+”-shaped fracture configuration is considered; the reference solution is computed on a 3⁷×3⁷ (i.e., 2187×2187) cell grid, while pEDFM grid operates at 10×10 resolution. From FIGS. 3A through 3E, it appears that in the case when the fracture network is highly conductive, the horizontal fracture is the one that dictates the flow. Consequently, successive simulations are conducted for both EDFM and pEDFM, while moving the horizontal fracture from top to bottom, as shown in FIGS. 5A and 5B. Their accuracy is measured using Eq. (11).

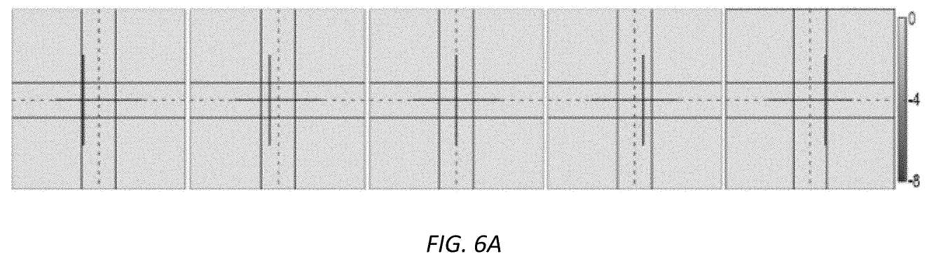

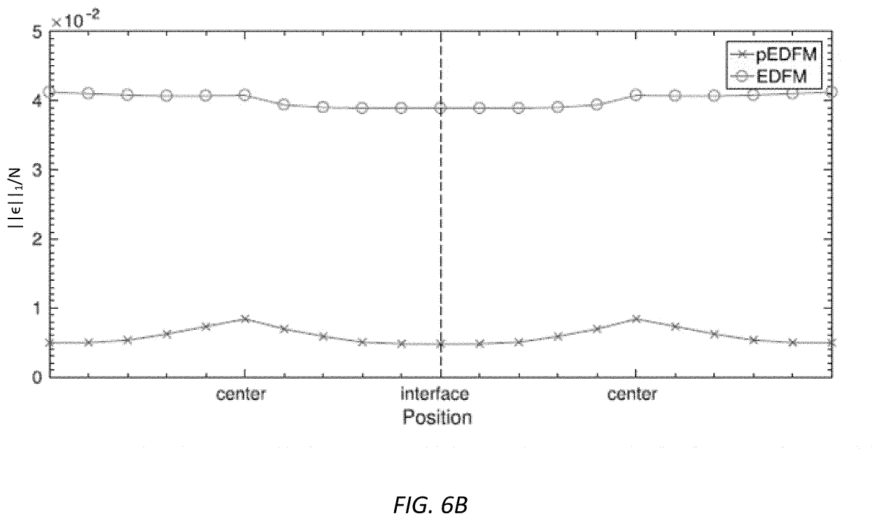

The results show that EDFM is relatively more accurate when fractures are placed at the cell center, rather than when they are close to the interface. However, once the fracture coincides with the interface, EDFM connects it to both matrix cells (each, with a CI calculated using S_{if}=A_{if} in Eq. (6), instead of 2 A_{if} as was the case in Eq. (8)), thus explaining the abrupt dip in error. In contrast, the pEDFM error attains its peak when fractures are placed at the cell centers and does not exhibit any jumps over the interface. The error of both methods lies within similar bounds (still pEDFM is relatively more accurate) showing that they are applicable to the case when fractures are relatively highly conductive. The consistent aspect of pEDFM is that, its results for the case when fractures coincide with the matrix interfaces, its results are identical to the DFM method, while—as explained before—this is not the case for EDFM. When the network is nearly impermeable, the location of the vertical fracture is relatively critical to the flow (FIGS. 4A through 4E). As such, for the purposes of the current experiment, the location of the vertical fracture will be shifted from left to right, as shown in FIGS. 6A and 6B. The resulting error plot shows a relatively dramatic increase for EDFM, when compared to FIGS. 6A and 6B, due to its inability to handle fractures with conductivities that lie below that of the matrix. pEDFM, on the other hand shows a similar behavior and error range as was observed in the case with highly conductive fractures, i.e., it retains its relatively high accuracy. These results show a promising trend for pEDFM, which is able to maintain reasonable representation accuracy of the effect of the embedded fractures. The slight increase in error for fractures placed near the matrix cell centers may be mitigated by employing moderate local grid refinements.

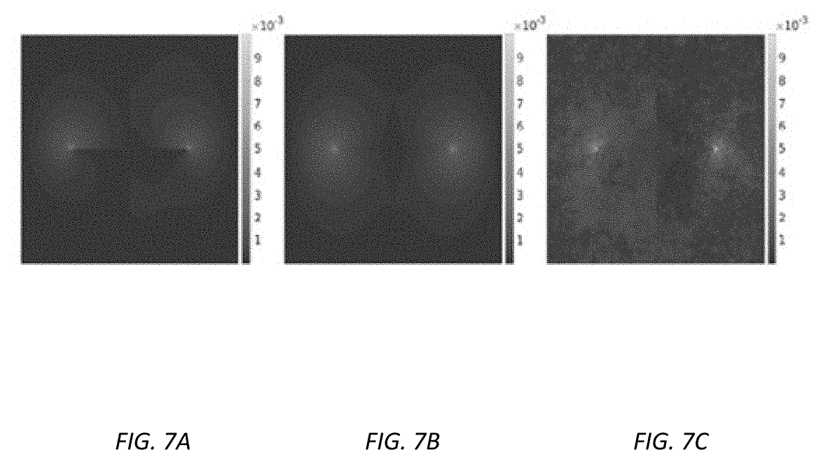

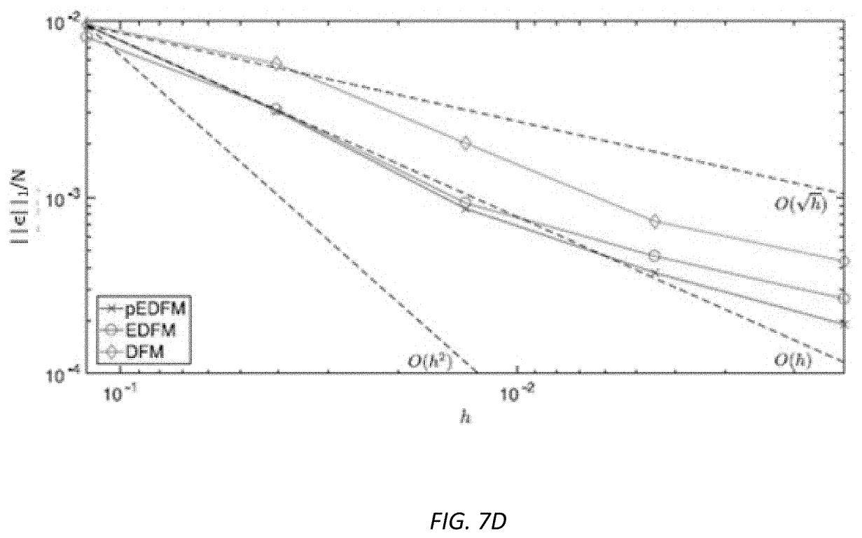

Another important factor in assessing the quality of an embedded fracture model is its order of accuracy with respect to the grid resolution. A series of nested matrix grids for the “+”-shaped fracture test case of FIGS. 3A through 3E and FIGS. 4A through 4E was constructed. The number of cells over each axis is gradually increased using Nx=Ny=3ⁱ formula, where i=2, 3, . . . , up to a reference grid resolution, where i=7. At the same time, the fracture grid is also refined accordingly such that its step size approximately matches the one in the matrix, h=Δx=Δy. The measure of accuracy for this case is similar to Eq. (11), where, this time, no interpolation is necessary, since the cell centroids are inherited from one level to another in the nested grid hierarchy. For a better comparison, alongside pEDFM and EDFM, the same sequence of geological scenarios was simulated using DFM on a 2D unstructured grid (Karimi-Fard et al., 2004), where the number of triangles was tweaked to match N=Nₓ×N_{y} as closely as possible and without imposing any preferential grid refinement around the fractures. The results of this study, in the case when the fractures are highly conductive, are depicted in FIGS. 7A through 7D. It follows that all three methods experience a linear decay in error with increasing grid resolution. The three error snapshots (FIGS. 7A through 7C), which were taken when Nₓ=N_{y}=3⁶ (or h=0. 0015), show that the pressure mismatch is mainly concentrated around the tips of the horizontal fracture, which represent the network's inflow and outflow points, respectively. In particular, FIG. 7A generally illustrates is the error for pEDFM, FIG. 7B generally illustrates is the error for EDFM, and FIG. 7C generally illustrates is the error for DFM. For EDFM (FIG. 7B and 7D), the error decays radially for points further away from these fracture tips. For pEDFM (FIG. 7A and 7D), the contour curves are slightly skewed, depending on the choice between upper and lower matrix interfaces for the fracture projection (both are equally probable since the horizontal fracture crosses the grid cell centroids).

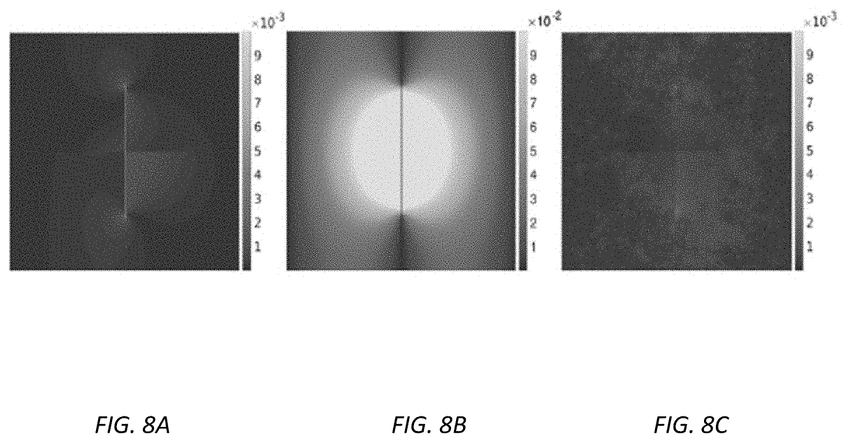

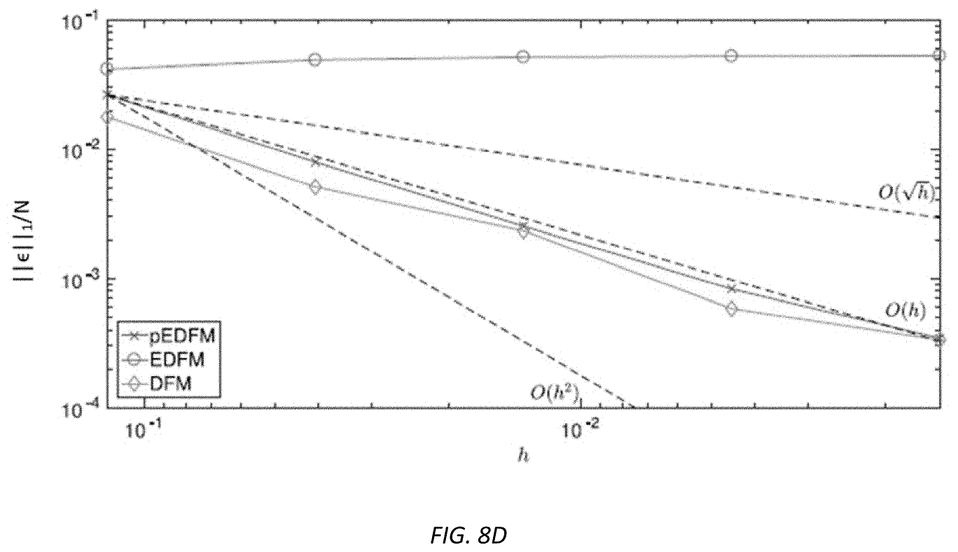

Finally, for DFM (FIG. 7C and 7D), the error distribution shows some heterogeneity, which is a consequence of using unstructured grids in a medium which, except for the neighborhood of the fractures, is homogeneous. The scenario when the fracture network is considered almost impermeable cannot be properly handled by EDFM, regardless of which grid resolution is used (FIGS. 8A through 8D). In particular, FIG. 8A generally illustrates is the error for pEDFM, FIG. 8B generally illustrates is the error for EDFM, and FIG. 8C generally illustrates is the error for DFM. This limitation is, once again, overcome by using pEDFM, which, similar to DFM, maintains its linear scalability with grid refinement on this challenging test case. The error snapshots depict that, this time, the pressure is inaccurate around the tips, as well as the body, of the vertical barrier. This can be explained by the fact that an embedded model on a coarse grid can have difficulty in placing the sharp discontinuity in the pressure field at exactly the right location. Still, the pressure mismatch decays with increasing grid resolution, suggesting that local grid refinements around highly contrasting fractures can benefit pEDFM, in a similar manner to DFM. To conclude, pEDFM shows a similar convergence behavior, in terms of grid resolution, to the widely used DFM approach. This confirms that, in order to diminish the model representation error, moderate local grid refinements can be applied near fractures.

In addition, the response of pEDFM was determined while changing the conductivity contrast between the “+”-shaped fracture network (k^{f}=10⁻⁸. . . , 10⁸) and the matrix (k^{m}=1). To this end, a coarse grid resolution of Nx=Ny=3⁵ was used and the resulting pressure was compared to that from the reference case, where

Nₓ=N_{y}=3⁷, using Eq. (11).

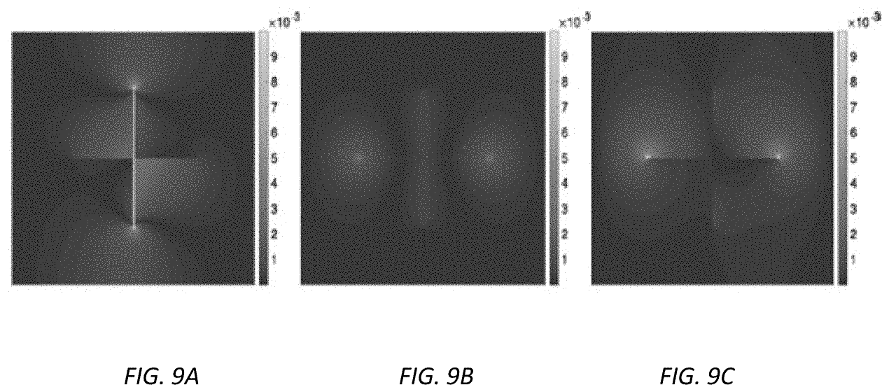

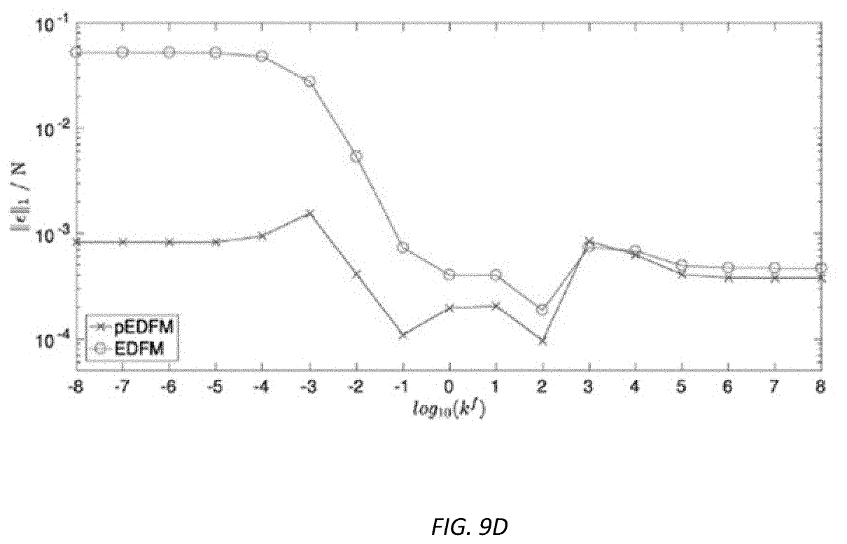

The results are depicted in FIGS. 9A through 9D and are in line with the conclusions above. Namely, for fracture log-permeabilities on the positive side of the spectrum, the results of EDFM and pEDFM are in agreement. As the permeability contrast passes 5 orders of magnitude, the pressure error plateaus, since, at beyond this stage, the fractures are the main drivers of the flow. However, for fracture permeabilities close to or below that of the matrix, the error of EDFM increases. pEDFM, on the other hand is able to cope with these scenarios, due to its formulation, its behavior showing an approximately symmetric trend, when compared to that of the positive side of the axis. The snapshots in FIGS. 9A through 9C, taken for lower, similar and higher fracture permeabilities with respect to the matrix, show the error in the pressure produced by pEDFM. The model inaccuracy is concentrated around the tips of fractures which actively influence the flow. Also note that there is a small error even in the case when k^{f}=k^{m}, since the pEDFM discretization is slightly different than that of a homogeneous reservoir. When the contrast is not high enough, such fractures can be homogenized into the matrix field.

### Test Cases

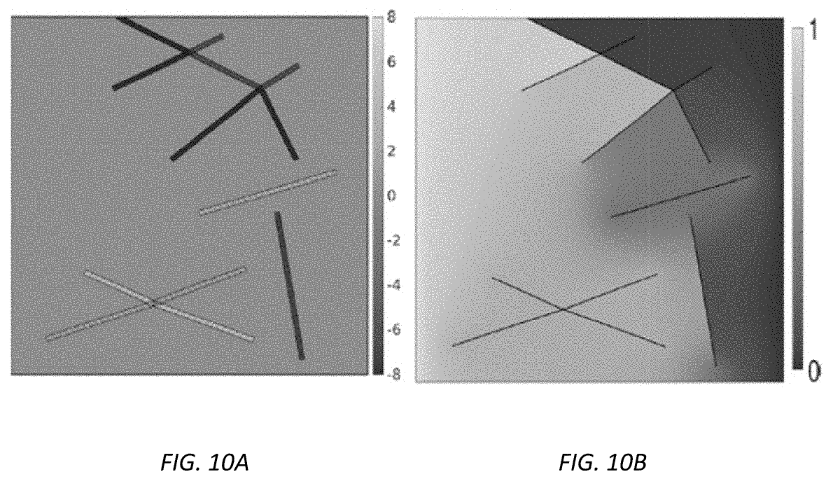

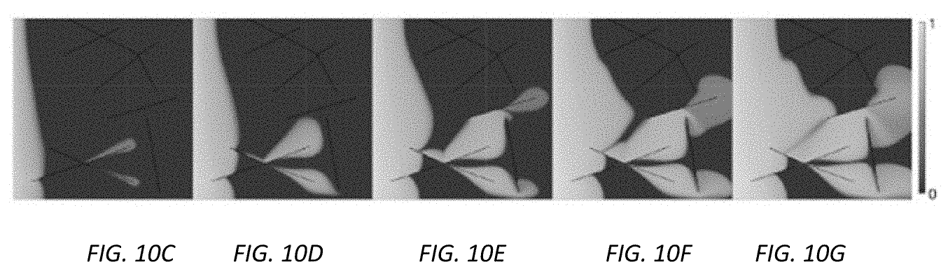

The performance of pEDFM in multiphase flow scenarios on 2D porous media with increasingly complex fracture geometries and heterogeneities was determined. Homogeneous matrix pEDFM is first applied in an incompressible 2-phase flow scenario through a 2D homogeneous domain which is crossed by a set of fractures with heterogeneous properties, as shown in FIGS. 10A through 10G. The boundary conditions are similar to those used for previous experiments, namely Dirichlet with non-dimensional values of p=1 and p=0 on the left and right edges, respectively, while the top and bottom sides are subject to no-flow conditions. The relatively low permeable fractures inhibit the flow, leaving only two available paths: through the middle of the domain and along the bottom boundary. As can be seen in the time-lapse saturation maps presented in FIGS. 10C through 10G, the front, indeed, respects these embedded obstacles. The injected fluid is mostly directed through the permeable X-shaped network and surpasses the vertical barrier, in the lower right part of the domain, on its way to the production boundary. This result reinforces the conclusion that the conservative pressure field obtained using pEDFM leads to transport solutions which honor a wide range of matrix-fracture conductivity contrasts.

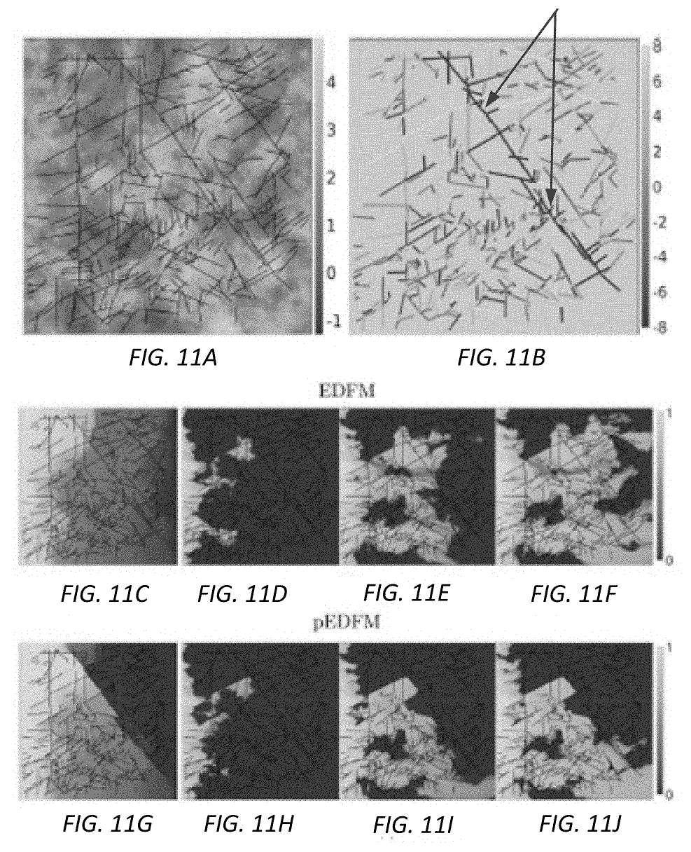

The behavior of EDFM and pEDFM were compared for simulating 2-phase incompressible flow through a 2D porous medium with heterogeneous (i.e. patchy) matrix permeability (FIBS 11A through 11J). The interplay between the relatively large-(matrix-matrix) and relatively small-scale (fracture-matrix) conductivity contrasts raises additional numerical challenges (Hamzehpour, H., Asgari, M. , Sahimi, M. , 2016. Acoustic wave propagation in heterogeneous two-dimensional fractured porous media. Phys. Rev. E 93 (6), 063305, which is fully incorporated herein by reference) and is a stepping stone in assessing the model's applicability to realistic cases. The embedded fracture map used for this test case (FIGS. 11A and 11B) is based on the Brazil I outcrop from Bertotti and Bisdom (Bertotti, G., Bisdom, K., Fracture patterns in the Jandeira Fm. (NE Brazil). http://data.4tu.nl/repository/uuid:be07fe95-417c-44e9-8c6a-d13f186abfbb, and Bisdom, K , Bertotti, G. , Nick, H. M. , 2016. The impact of different aperture distribution models and critical stress criteria on equivalent permeability in fractured rocks. J. Geophys. Res. 121 (5), 4045-4063, both of which are fully incorporated herein by reference). The conductivities of the fractures forming the North-West to South-East diagonal streak, were set to 10 ⁻⁸, thus creating an impermeable flow barrier across the domain (noticeable in dark blue on the top-right, FIG. 11B—see line arrows are pointing to). For the rest of the fractures, permeabilities were randomly drawn from a log-uniform distribution supported on the interval [10⁻⁸, 10⁸]. Finally, similar to previous experiments, fixed pressure boundary conditions p=1 and p=0 are set on the left and right edges, respectively, while the top and bottom sides are subject to no-flow conditions. The middle row of plots from FIGS. 11C through 11F show the pressure field and time-lapse saturation results obtained using EDFM. Note that the injected fluid is allowed to bypass the diagonal flow barrier, towards the production boundary. This, once again shows the limitation of EDFM, which is only able to capture the effect of fractures with permeabilities higher than the matrix. However, by disregarding flow barriers, EDFM delivers an overly optimistic and nonrealistic production forecast. In contrast to EDFM, the pressure field obtained using pEDFM shows sharp discontinuities (FIG. 11G). The accompanying saturation plots confirm that the injected phase is confined by the diagonal barrier and forced to flow through the bottom of the domain, thus significantly delaying its breakthrough towards the production boundary. These results confirm that pEDFM outperforms to EDFM, due to its applicability in cases with complex and dense fracture geometries and in the presence of matrix heterogeneities.

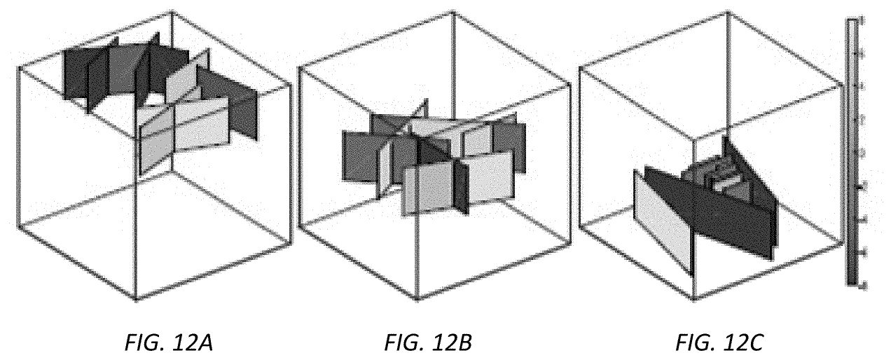

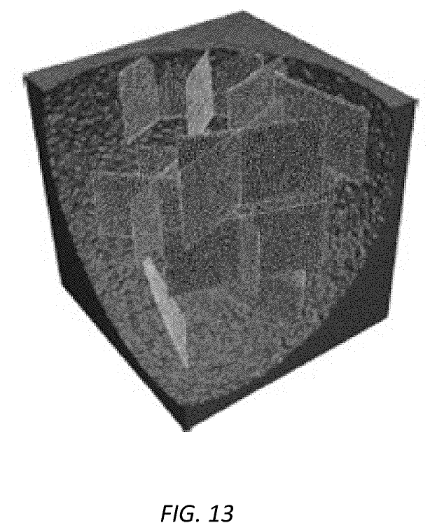

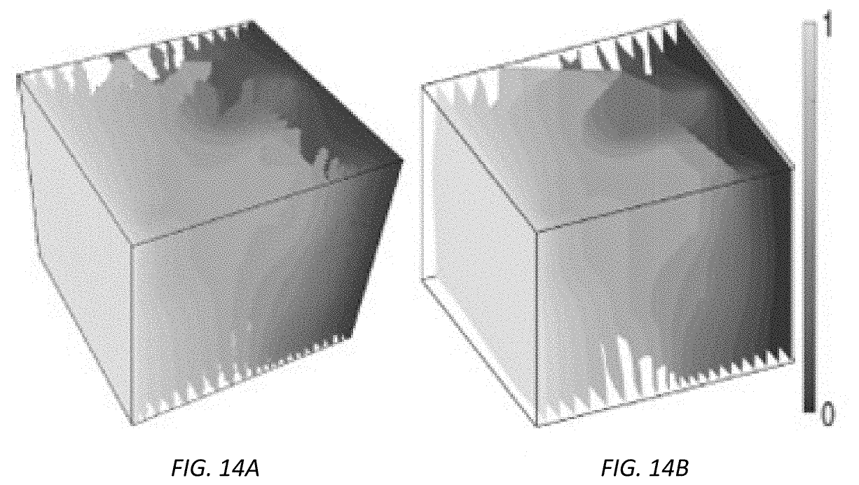

A test case on a 3D domain containing 3 layers of fractures, stacked along the Z axis (FIGS. 12A through 12C) was conducted. The top layer (FIG. 12A) is a vertically extruded version of the 2D fracture map from FIGS. 10A through 10G. The second layer (FIG. 12B) consists of a single fracture network whose intersecting plates have highly heterogeneous properties. Finally, the third layer (FIG. 12C) is represented by 3 large individual plates, with a cluster of small parallel fractures packed in between. In this scenario, the incompressible single-phase flow is driven from the left boundary, where the pressure is set to the non-dimensional value of p=1, towards the right, where p=0, while all the other boundaries of the domain are subject to no-flow conditions. No other source terms are present and gravity and capillary effects are neglected. The results of pEDFM, on a matrix grid with Nₓ=N_{y}=N_{z}=100 and a total of 23381 fracture cells, are compared to those obtained using DFM on an unstructured grid (FIG. 13), where the number of tetrahedra (matrix) and triangles (fractures) were chosen to approximately match the degrees of freedom on the structured grid. The two pressure fields are plotted in FIGS. 14A and 14B using iso surfaces for equidistant values, and are in good agreement, for decision—making purposes. This last numerical experiment shows that pEDFM has good potential for field-scale application.

Projection-based Embedded Discrete Fracture Model (pEDFM) was devised, for flow simulation through fractured porous media. It inherits the grid flexibility of the classic EDFM approach. However, unlike its predecessor, its formulation allows it to capture the effect of fracture conductivities ranging from relatively highly permeable networks to inhibiting flow barriers. The new model was validated on 2D and 3D test cases, while studying its sensitivity towards fracture position within a matrix cell, grid resolution and the cross-media conductivity contrast. The results show that pEDFM may be scalable and able to handle dense and complex fracture maps with heterogeneous properties in single-, as well as multiphase flow scenarios. Finally, its results on structured grids were found comparable to those obtained using the DFM approach on unstructured, fracture-conforming meshes. In conclusion, pEDFM is a flexible model, its simple formulation recommending it for implementation in next-generation simulators for fluid flow through fractured porous media.

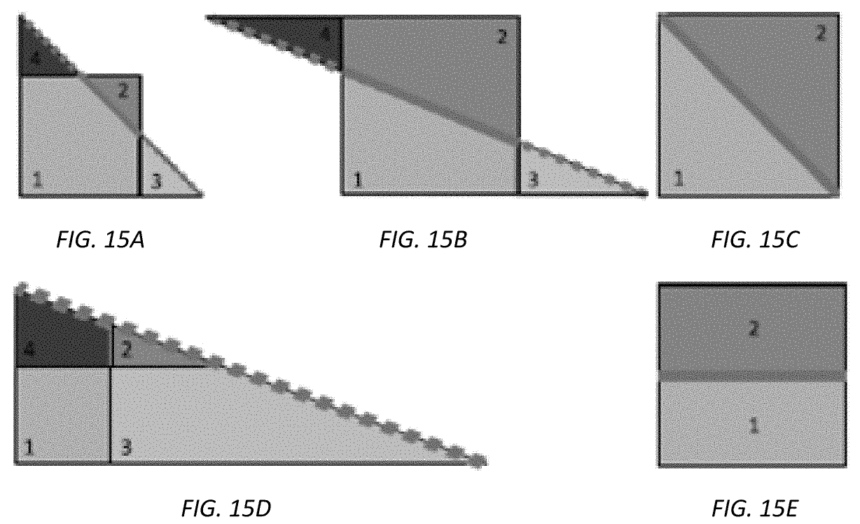

Turning again to an example of an analytical method for the computation on 2D structure grids noted above, the computation of the average distance between a matrix control volume and a fracture surface, which appears in Eqs. (6) and (10), may involve numerical integration for arbitrarily shaped cells. For 2D structured grids, however, analytical formulas were given in Hajibeygi et al. (2011) for a few specific fracture orientations. To handle fracture lines with arbitrary orientation (adapted from Pluimers, S., 2015. Hierarchical Fracture Modeling. Delft University of Technology, The Netherlands Msc thesis, which is fully incorporated herein by reference), the interfaces of each cell intersected by a fracture are extended until they intersect the fracture line, resulting in four right triangles with surfaces A 1 to A 4, as shown in FIGS. 15A-15E. Then, given the average distance between each triangle and its hypotenuse, <d>1 to <d>4, as (see Hajibeygi et al. (2011)),

$${〈 d 〉}_{i} = \frac{{Lx}_{i} \cdot {Ly}_{i}}{3 \sqrt{{Lx}_{i}^{2} + {Ly}_{i}^{2}}} , \qquad ( A .1 )$$

where Lₓᵢ and L_{yi} are the lengths of the axis-aligned sides of triangle i, the average distance between grid cell i and fracture line f is obtained,

$${〈 d 〉}_{if} = \frac{{A}_{1} {〈 d 〉}_{1} + {A}_{2} {〈 d 〉}_{2} - {A}_{3} {〈 d 〉}_{3} - {A}_{4} {〈 d 〉}_{4}}{{A}_{1} + {A}_{2} - {A}_{3} - {A}_{4}} . \qquad ( A .2 )$$

Note that no modification is required to the formula in the case when fractures lie outside the cell, i.e. for the non-neighboring connections from Eq. (10). In addition, this procedure can be applied to 3D structured grids where fractures are extruded along the Z axis, while a generalization for fracture plates with any orientation is the subject of future research.

The foregoing description of several methods and embodiments has been presented for purposes of illustration. It is not intended to be exhaustive or to limit the claims to the precise steps and/or forms disclosed, and obviously many modifications and variations are possible in light of the above teaching.

### THE FOLLOWING ARE FULLY INCORPORATED HEREIN BY REFERENCE

Ahmed, R., Edwards, M. G., Lamine, S., Huisman, B. A., Pal, M., 2015. Three-dimensional control-volume distributed multi-point flux approximation coupled with a lower-dimensional surface fracture model. J. Comput. Phys. 303,470-497.

Berkowitz, B., 2002. Characterizing flow and transport in fractured geological media: a review. Adv. Water Res. 25 (8-12), 861-884.

Bertotti, G., Bisdom, K., Fracture patterns in the Jandeira Fm. (NE Brazil). http://data.4tu.nl/repository/uuid:be07fe95-417c-44e9-8c6a-d 13f186abfbb.

Bisdom, K., Bertotti, G., Nick, H. M., 2016. The impact of different aperture distribution models and critical stress criteria on equivalent permeability in fractured rocks. J. Geophys. Res. 121 (5), 4045-4063.

Chen, Z., 2007. Reservoir simulation: mathematical techniques in oil recovery. SIAM.

Deb, R., Jenny, P., 2016. Numerical modeling of flow-mechanics coupling in a fractured reservoir with porous matrix. Proc. 41st Workshop Geotherm. Reservoir Eng., Stanford, Calif., February 22-24, SGP-TR-209. 1-9.

Flemisch, B., Berre, I., Boon, W., Fumagalli, A., Schwenck, N., Scotti, A., Stefansson, I., Tatomir, A., 2017. Benchmarks for single-phase flow in fractured porous media. ArXiv:1701.01496.

Flemisch, B., Fumagalli, A., Scotti, A., 2016. A review of the XFEM-based approximation of flow in fractured porous media. In: Advances in Discretization Methods. Springer, pp. 47-76.

Fumagalli, A., Pasquale, L., Zonca, S., Micheletti, S., 2016. An upscaling procedure for fractured reservoirs with embedded grids. Water Resour. Res. 52 (8), 6506-6525.

Fumagalli, A., Zonca, S., Formaggia, L., 2017. Advances in computation of local problems for a flow-based upscaling in fractured reservoirs. Math. Comput. Simul. 137,299-324.

Garipov, T. T., Karimi-Fard, M., Tchelepi, H. A., 2016. Discrete fracture model for coupled flow and geomechanics. Comput. Geosci. 20 (1), 149-160.

Hajibeygi, H., Karvounis, D., Jenny, P., 2011. A hierarchical fracture model for the iterative multiscale finite volume method. J. Comput. Phys. 230,8729-8743.

Hamzehpour, H., Asgari, M., Sahimi, M., 2016. Acoustic wave propagation in heterogeneous two-dimensional fractured porous media. Phys. Rev. E 93 (6), 063305.

Karimi-Fard, M., Durlofsky, L. J., 2016. A general gridding, discretization, and coarsening methodology for modeling flow in porous formations with discrete geo-logical features. Adv Water Resour. 96 (6), 354-372.

Karimi-Fard, M., Durlofsky, L. J., Aziz, K., 2004. An efficient discrete fracture model applicable for general purpose reservoir simulators. SPE J. 9 (2), 227-236.

Karvounis, D., Jenny, P., 2016. Adaptive hierarchical fracture model for enhanced geothermal systems. Multiscale Model. Simul. 14 (1), 207-231.

Lee, S. H., Jensen, C. L., Lough, M. F., 2000. Efficient finite-difference model for flow in a reservoir with multiple length-scale fractures. SPE J. 3,268-275.

Li, L., Lee, S. H., 2008. Efficient field-scale simulation of black oil in naturally fractured reservoir through discrete fracture networks and homogenized media. SPE Reservoir Eval. Eng. 11,750-758.

Matthäi, S. K., Mezentsev, A. A., Belayneh, M., 2007. Finite element node-centered finite-volume two-phase-flow experiments with fractured rock represented by unstructured hybrid-element meshes. SPE Reservoir Eval. Eng. 10,740-756.

Moinfar, A., Varavei, A., Sepehrnoori, K., Johns, R. T., 2014. Development of an efficient embedded discrete fracture model for 3d compositional reservoir simulation in fractured reservoirs. SPE J. 19,289-303.

Moortgat, J., Amooie, M., Soltanian, M., 2016. Implicit finite volume and discontinuous galerkin methods for multicomponent flow in unstructured 3d fractured porous media. Adv. Water Resour. 96,389-404.

Moortgat, J., Firoozabadi, A., 2013. Three-phase compositional modeling with capillarity in heterogeneous and fractured media. SPE J. 18,1150-1168.

Norbeck, J. H., McClure, M. W., Lo, J. W., Home, R. N., 2016. An embedded fracture modeling framework for simulation of hydraulic fracturing and shear stimulation. Comput. Geosci. 20 (1), 1-18.

Pluimers, S., 2015. Hierarchical Fracture Modeling. Delft University of Technology, The Netherlands Msc thesis.

Reichenberger, V., Jakobs, H., Bastian, P., Helmig, R. ,2006. A mixed-dimensional finite volume method for two-phase flow in fractured porous media. Adv. Water Resour. 29 (7), 1020-1036.

Sahimi, M., Darvishi, R., Haghighi, M., Rasaei, M. R., 2010. Upscaled unstructured computational grids for efficient simulation of flow in fractured porous media. Transp. Porous Media 83 (1), 195-218.

Schwenck, N., Flemisch, B., Helmig, R., Wohlmuth, B., 2015. Dimensionally reduced flow models in fractured porous media: crossings and boundaries. Comput. Geosci. 19 (1), 1219-1230.

Shah, S., Moyner, O., Tene, M., Lie, K.-A., Hajibeygi, H., 2016. The multiscale restriction smoothed basis method for fractured porous media (F-MsRSB). J. Comput. Phys. 318,36-57.

Tatomir, A., Szymkiewicz, A., Class, H., Helmig, R., 2011. Modeling two phase flow in large scale fractured porous media with an extended multiple interacting continua method. Comput. Model. Eng. Sci. 77 (2), 81.

Tene, M., Al Kobaisi, M., Hajibeygi, H., 2016. Multiscale projection-based Embedded Discrete Fracture Modeling approach (F-AMS-pEDFM). In: ECMOR XV-15th European Conference on the Mathematics of Oil Recovery.

Tene, M., Al Kobaisi, M. S., Hajibeygi, H., 2016. Algebraic multiscale method for flow in heterogeneous porous media with embedded discrete fractures (F-AMS). J. Comput. Phys. 321, 819-845.

What is claimed is:

1. A projection-based embedded discrete fracture model (pEDFM) method for simulation of flow through subsurface formations comprising:
independently defining one or more fracture and a matrix grids;
identifying cross-media communication points; and
adjusting one or more matrix-matrix and a fracture-matrix transmissibilities in a vicinity of a fracture network.

2. The pEDFM method of claim 1, further comprising automatically scaling matrix-matrix connections in said vicinity of said fracture network.

3. The pEDFM method of claim 1, further comprising adding one or more additional fracture-matrix connections.

4. The pEDFM method of claim 1, further comprising automatically providing results to a DFM.

5. A projection-based embedded discrete fracture model (pEDFM) method for simulation of flow through subsurface formations comprising:
selecting a set of matrix-matrix interfaces such that said matrix-matrix interfaces define a continuous projection path of each fracture network on a matrix domain; and
defining transmissibilities based, at least in part on, areas of matrix-interfaces hosting fracture cell projections and effective fluid mobilities between corresponding cells.

6. The pEDFM method of claim 5, wherein said transmissibilities are defined as follows:
$${T}_{if} = \frac{{A}_{if}}{{〈 d 〉}_{if}} {λ}_{if} , {T}_{{i}_{e} f} = \frac{{A}_{if ⊥ {x}_{e}}}{{〈 d 〉}_{{i}_{e} f}} {λ}_{{i}_{e} f} and {T}_{{ii}_{e}} = \frac{{A}_{{ii}_{e}} - {A}_{if ⊥ {x}_{e}}}{Δ {x}_{e}} {λ}_{{ii}_{e}} ,$$
where Aᵢᵢₑ are the areas of the matrix interfaces hosting the fracture cell projections and λ_{if}, λ_{ief}, λᵢᵢₑ are effective fluid mobilities between the corresponding cells.

7. The pEDFM method of claim 6, wherein for fractures that are explicitly confined to lie along interfaces between matrix cells, said pEDFM method reduces to the DFM approach on unstructured grids.

8. The pEDFM method of claim 5, further comprising:
performing two-point-flux approximation (TPFA) finite volume discretization to obtain a coupled system;
applying backward Euler time integration; and
linearizing said coupled system with a Newton-Raphson scheme.

9. The pEDFM method of claim 8, wherein said backward Euler time integration is applied to said coupled system.

10. The pEDFM method of claim 8, wherein said TPFA is based, at least in part, on mass-conservation equations for isothermal Darcy flow in fractured media, without compositional effects.
